(19) United States
(12) Patent Application Publication
(10) Pub. No.: US 2011/0190429 A1
(43) Pub. Date: Aug. 4, 2011

(54) COLOURED INK AND A METHOD FOR FORMULATING A COLORED INK

(75) Inventors: Iraqi Muhammad, Tira (IL); Yifat Bareket, Reut (IL)

(73) Assignee: CAMTEK LTD.

(21) Appl. No.: 12/742,096

(22) PCT Filed: Nov. 5, 2008
(86) PCT No.: PCT/IL08/01454

§ 371 Date: Apr. 26, 2011

(30) Foreign Application Priority Data
Nov. 8, 2007 (US) 60996264

(51) Int. Cl. C09D 11/10; C09D 11/02; C08K 5/1515; C08K 5/103

(52) U.S. Cl. 524/114; 106/31.9; 524/317; 524/500; 524/540

(57) ABSTRACT

A method for preparation of a colored ink that includes: preparing a white formulation that comprises sub-micron inorganic pigment; preparing a colored formulation that comprises sub-micron organic pigment; and mixing and grinding the white ink formulation and the colored ink formulation to provide a colored ink formulation suitable for jet ink applications. A colored ink that includes white sub-micron inorganic pigment and colored sub-micron organic pigment; wherein the colored ink is characterized by a high (color) hiding power and color density, and can meet the requirements of the PCB industry.

### RELATED APPLICATIONS

This application claims priority from U.S. provisional patent Application Ser. No. 60/996,264, filing date Nov. 8, 2007.

### FIELD OF INVENTION

The invention relates to a colored ink that can, be used, for example, for ink jet applications and especially for the printed circuit board (PCB) industry

### BACKGROUND OF THE INVENTION

Ink Jet inks are special liquids that are applied by ink-jet printers as discrete droplets onto a substrate. The ink-jet technology, in comparison with other conventional printing technologies, allows the formation of an image without the need of screens and photo masks and the application of the ink only when drop is required (drop-on-demand). The result is thus cost effective and presents a high degree of flexibility from the user standpoint.

Ink jet methodologies have been widely adopted for industrial marking, office printing (of both text and graphics), signage in display graphics (e.g., photographic reproduction, business and courtroom graphics, graphic arts), and the like for numerous reasons. One important reason is the ease of operation and great versatility in terms of the variety of substrates that can be treated, as well as the print quality and the speed of operation that can be achieved.

The ink-jet printing process involves the ejection of fine droplets of ink onto a print medium (the substrate), typically in response to electrical signals generated by a microprocessor. Typically, an ink-jet printer utilizes plurality of printing heads mounted on a carriage that is moved relative to the surface of the substrate or static heads on a bridge and moving substrate.

The printing heads typically include orifice plates that have very small nozzles (typically 10-50 μm diameter) through which the ink droplets are ejected. Adjacent to these nozzles are ink chambers where ink is stored prior to ejection. The mechano-acoustic nature of the printing heads requires that the ink viscosity be kept in the range of about 8-14 Cps at the jetting temperature and the surface tension of the ink should be kept in the range of about 26-34 dynes/cm. If, for example, the viscosity and/or the surface tension fall outside of the optimal parameters, the printing quality may be affected.

Inkjet methodologies have found use in a great number of versatile applications, ranging from the application of ink formulations for the purpose of printing to the depository of biological material for biological applications. One of the great number of publications which disclose or report on the vast variety of ink-jet formulations known to date is US application no. 2005/0171237. This application discloses a fully curable jettable composition having a viscosity of less than 30 cps at a temperature within the range of 15 to 180° C. This composition comprises (A) at least one low viscosity reactive resin having a molecular weight not greater than 300 Daltons and a viscosity at a temperature in the said range of less than 30 cps; (B) at least one higher viscosity resin having a viscosity twice as larger as the low viscosity resin at the same temperature; (C) at least one curable toughener; (D) at least one initiator for the polymerization of the resins; and (E) at least one stabilizer for the delaying the curing of the resins of the composition.

Ink-jet inks for the PCB industry are unique formulations that not only need to meet the chemical and physical characteristics required of ink-jet formulations, but also need to meet the requirements of the PCB industry, e.g., chemical resistance against process media, assembly processes and long-term durability of the assembled board.

One specific use of the formulations is as marking inks (legend), which are applied onto the bare board or metal conductors and pads or the solder mask coated board, in order to accurately mark the placement of components, or add serial numbers, barcodes or trademarks.

Yet another specific use of the formulations is in generating solder masks. Solder mask is a coating layer made of polymer that coats copper traces of a printed circuit board (PCB) and prevents solder from bridging between conductors.

Israeli patent application no. IL2006/000959 discloses the concept of thermosetting solvent based ink jet formulation which is based on a unique combination of phenolic resin, amino resin, and polyol as the major polymeric matrix, combined with a high level of titanium dioxide as opaque and white filler. The unique formulation exhibits all special requirements for ink jet inks as low viscosity, surface tension control, nanosize particles and good dispersion stability. The thermal curing procedure enables cross-linking which contributes to the final applied inks performance in accordance with PCB's special regulation.

There is a growing need to provide inks that can be used for ink-jet applications, especially for printed circuit board industry.

### SUMMARY OF THE INVENTION

It is provided a colored ink that can be cured by heat (thermosetting ink) or by radiation (for example Ultra Violet curable ink) or a combination thereof.

The colored ink can be used in various applications including but not limited to PCB application such as legend and solder mask.

A method for preparation of a colored ink is provided. It includes preparing a white formulation that comprises sub-micron inorganic pigment; preparing a colored formulation that comprises sub-micron organic pigment; and mixing and grinding the white ink formulation and the colored ink formulation to provide a colored ink formulation suitable for jet ink applications.

A colored ink is provided. It includes white sub-micron inorganic pigment and colored sub-micron organic pigment; wherein the colored ink is characterized by a high color hiding.

A colored ink is provided. It includes white sub-micron inorganic pigment and colored sub-micron organic pigment; wherein an aggregate volume of the white sub-micron inorganic pigment is at least twice an aggregate volume of the colored sub-micron organic pigment.

A colored ink is provided. It includes white sub-micron inorganic pigment and colored sub-micron organic pigment; wherein an aggregate volume of the white sub-micron inorganic pigment is at least thrice an aggregate volume of the colored sub-micron organic pigment.

A colored ink is provided. It includes white sub-micron inorganic pigment and colored sub-micron organic pigment; wherein an aggregate volume of the colored sub-micron organic pigment is smaller than thirty percent of a volume of the colored ink.

A colored ink is provided. It includes white sub-micron inorganic pigment and colored sub-micron organic pigment; wherein the colored ink is compatible to printed circuit board application.

A colored ink is provided. It includes white sub-micron inorganic pigment and colored sub-micron organic pigment; wherein each colored sub-micron organic pigment out of a large group of colored sub-micron organic pigment is substantially surrounded by multiple white sub-micron inorganic pigment.

A method for ink jet printing is provided it includes providing a colored ink as mentioned above; ink-jetting the colored ink onto a substrate; and curing the ink-jetted colored ink.

A method for ink jet printing, comprising: manufacturing the colored ink according to any mentioned above; ink-jetting the colored ink onto a substrate; and curing the ink-jetted colored ink.

### DETAILED DESCRIPTION OF VARIOUS EMBODIMENTS OF THE INVENTION

### Terminology

The term “resin” refers to a monomer, oligomer, polymer or any combination of said compounds characterized by an average of more than one reactive group per molecule, said reactive group being able to react with a second reactive compound (so called “cross linker”) to form a cross-linked thermosetting network.

“Amino resins” are amine-based reactive compounds which may be selected from melamine monomer or polymer, melamine-formaldehyde resins, benzoguanamine-formaldehyde resins, urea-formaldehyde resins, glycolurilformaldehyde resins, triazine based amino resins and combinations thereof. Typical amino resins include the melamine resins manufactured by CYTEC such as Cymel 300, 301, 303, 325 350, 370, 380, 1116 and 1130; benzoguanamine resins such as Cymel R 1123 and 1125; glycoluril resins such as Cymel 1170, 1171, and 1172 and urea resins such as CYMEL U-H-160-BX-CYMEL UMO-E.

Amino resins can be of the polymeric and oligomeric type, react readily with the polyol and phenolic resin at temperature greater than 100° C., and more preferred at temperatures greater than 120° C. without losing latency during storage at ambient. Introduction of such polymeric or oligomeric resins improves adhesion to metallic surfaces as well as cross-linking efficiency. Examples for polymeric and oligomeric type amino resins are CYMEL 325, CYMEL 322, CYMEL 3749, CYMEL 3050, CYMEL 1301 melamine based resins, CYMEL U-14-160-BX, CYMEL UI-20-E urea based amino resins, CYMEL 5010 and benzoguanamine based amino resin and CYMEL 5011 based amino resins, manufactured by CYTEC. Amino resins can be monomelic type amino resins such as CYMEL 300, CYMEL 303, CYMEL 1135 melamine based resins, CYMEL 1123 benzoguanamine based amino. CYMEL 1170 and CYMEL 1171 Glycoluril amino resins and Cylink 2000 triazine based amino resin, manufactured by CYTEC. When monomelic type amino resins are used, blocked acidic catalyst is required at amount of about 0.1-8% of the total weight of the formulation, preferably in the range of 0.5-5%. Examples of such catalysts are amine or organic blocked aromatic acids, such as NACURE 1323, NACURE 5414, and NACURE 1953, manufactured by King Industries. The amino resins are reactive towards hydroxyl, carboxyl or amide containing molecules, most often with the hydroxyl containing compounds due to the hydroxyl's reactivity and wide spectrum of raw materials. The term “polyol” refers to any compound, selected in non limiting manner from aliphatic, aromatic, heterocyclic, alicyclic compounds, silicon containing compounds, having at least one hydroxyl (OH) group bonded thereto. The hydroxyl group is one capable of reacting with said amino resin and phenolic resin, as will be discussed hereinnext. The polyol component in the formulation should provide compatibility between the amino resin and the phenolic resin. At the same time, the polyol should also have good chemical and thermal resistance. Aromatic polyols are preferred. Ester groups in the main chain of said polyol are typically not recommended.

“Phenolic resins” are phenol-based resins which are selected from phenol aldehyde condensates (known as Novolak resins) including hydrogenated grades thereof, homopolymers and copolymers of alkenyl phenols including hydrogenated grades thereof, poly(vinyl phenol) resins including co-polymers thereof with other unsaturated monomers such as styrene, acrylic or methacrylic acid and esters thereof, and including hydrogenated grades of said resins, polymers comprising phenolic units and non-aromatic cyclic alcohol units including hydrogenated grades thereof, and homo-polymers and co-polymers of N-hydroxyphenyl-maleimides. One class of phenolic resins includes etherified phenol resins—especially etherified phenol formaldehyde or cresol formaldehyde grades which are more latent, less viscous, more ductile and have clear-light color after curing. Another class of phenolic resins is polyvinyl phenol polymers including co-polymers thereof with other unsaturated monomers such as styrene, acrylic or methacrylic acid and esters thereof, and including hydrogenated grades of said resins. The phenolic resin is typically one which is light yellow in color or has a water-clear color before curing. Phenolic resins are reactive to primary and secondary aliphatic OH groups, as well as with themselves (self-condensation) and with epoxy (oxirane groups). This reaction is typically catalyzed by acids, polyols, solvents, monomers, polymers, oligomers, non reactive compounds, defoamers, wetting agents, dispersing agents, and adhesion promoters until a clear solution was obtained.

The term “polyol” refers to any compound, selected in non limiting manner from aliphatic, aromatic, heterocyclic, alicyclic and silicon containing compounds, having at least one hydroxyl (OH) group bonded thereto. The hydroxyl group is one capable of reacting with said amino resin and phenolic resin, as will be discussed hereinnext. The polyol is most preferably a low molecular weight monomer or oligomer, characterized by molecular weight lower than 5,000 Dalton, more preferred less than 2,000 Daltons. The polyol may also contain inorganic atoms such as sulfur, phosphor, nitrogen, halogens, silicone, zirconium or combinations thereof. Preferably, said polyol contains at least 1 hydroxyl group; more preferably, said polyol has at least two hydroxyl groups; even more preferably, said polyol consists of between 2 and 20 hydroxyl groups. When specifying a certain or generic polyol having, for example, at least 2 hydroxyl groups, a reference is made to a polyol having 2 or more hydroxyl groups per every one molecule of polyol. For example, there may be 2 hydroxyl groups per molecule, 2, 3, 4, 5, 6, 7, 8, 9, 10, 11, 12, 13, 14, 15, 16, 17, 18, 19, 20, 30, 50 or more hydroxyl groups per polyol molecule or any other number of hydroxyl groups per a single molecule of polyol. In one preferred embodiment, the polyol has an OH equivalent weight lower than 600, namely the molecular weight of the polyol divided by the average number of reactive hydroxyl groups contained in said polyol is lower than 600. Non-limiting examples of the polyols are diglycidyl ether of bisphenol A (DGEBA), diglycidyl ether of bisphenol F (DGEBF), diglycidyl ether of bisphenol S(DGEBS)₅ phenoxy resins manufactured by InChem, cycloaliphatic polyols such as cyclohexane dimethanol (for example the diol UNOXOL manufactured by DOWO or ethoxylates thereof, ethoxylated or propoxylated polyhydric alcohols for example BOLTRON polyols and ethoxylated pentaerythritol by Perstrop) and heterocyclic based polyols, copolymers of unsaturated aromatic monomer, such as styrene and hydroxyl containing unsaturated monomer, for example Styrene-Allyl alcohol copolymers manufactured by Lyondell Corporation under the brand name SAA. Another family of high functionality polyols is the group of polyols manufactured by free radical, anionic or cationic copolymerization of unsaturated hydroxyls containing compound with unsaturated monomers such as styrene, acrylic and methacrylic esters, allyl ethers, vinyl monomers and maleic anhydride or its derivatives. The polyol is additionally characterized as having (a) good solubility in ketones, esters, carbonates and ether solvents; (b) at least one primary or secondary aliphatic OH group; (c) high hydrolytic and oxidative stability; (d) good reactivity with amino and phenolic resins; and (e) light in color. The hydroxyl groups may be primary or secondary. The polyols may contain only primary, only secondary or a combination of primary and secondary hydroxyl groups. Most preferred are aliphatic hydroxyls, which are more reactive than aromatic ones.

A dispersing agent can be selected from low molecular weight dispersants, capable of penetrating into agglomerates of pigment and fillers and thus lower the attraction forces between particles and high molecular weight dispersants that prevent re-agglomeration. For example the low molecular weight dispersant may be DISPERBYK 1 10 and 111 acidic copolymers manufactured by BYK-CHEMIE and the high molecular weight dispersants may be DISPERBYK 161, DISPERBYK163 and 168 copolymers manufactured by BYK-CHEMIE. In still a further embodiment, the formulation, further comprises at least one organic solvent, preferably in quantities ranging from between about 5 and 60%, more preferably from between about 1 and 50%, and more preferably from between about 1 and 30% of the total weight of the formulation. The solvent should have medium to low volatility to avoid pre-mature drying of ink in the ink-jet nozzles, surface tension in the range of 20 to 55 dynes/cm and viscosity of at most 20 Cps at ambient temperatures. Preferred solvents are selected from ethers, alcohols, glycols, lactones, cyclic esters and cyclic amides esters, ether-esters, alkyl carbonates, ketones, aromatic, aliphatic, amide, aliphatic, cycloaliphatic, silicon atom containing solvents, and combinations thereof. Specific solvents are, for example, Dowanol PMA and Dowanol DPM manufactured by DOW, propylene carbonate, Methylene glycol dimethyl ether, Solvesso 150 manufactured by DownMobil, gamma-Butyrolactone, and NMP (N-methyl-2-pyrrolidone).

The term “surface tension” refers to a property of liquids arising from unbalanced molecular cohesive forces at or near the surface, as a result of which the surface tends to contract and has properties resembling those of a stretched elastic membrane. Surface tension, measured in Newtons per meter (N-m′¹), or Dynes per cm, is represented by the symbol σ or γ or T and is defined as the force along a line of unit length perpendicular to the surface, or work done per unit area.

Surprisingly, when phenolic resins are incorporated into the amino resin/polyol mixture, even in small amounts, e.g. between about 1-15% of total ink weight, the chemical and thermal resistance of the ink formulation improves dramatically. The most effective content is 1-8% of total ink weight, where chemical and thermal resistance, is excellent, and the color is neutral with almost no dark discoloration. Such a coloring allows pigmentation of the ink to almost any color and/or shade, including white. In order to minimize coloration of cured film, selected grades of phenolic resins are most preferred. These are for example etherified phenolic resins, for example the grade FB210B60 manufactured by Schenectady, hydrogenated phenolic resins, vinyl phenols and copolymers thereof and hydrogenated vinyl phenol resins, for example MARUKA LYNCUR resins, manufactured by MARUZEN Japan. In order to cure or more preferably to enable significant increase in viscosity of the formulation of the invention, the printed ink is exposed to UV or visible, light provided by suitable sources of actinic radiation include halogen light, mercury lamps, xenon lamps, carbon arc lamps, tungsten filament lamps, lasers, electron beam and sunlight.

Ultraviolet (UV) radiation is preferably emitted by medium pressure mercury lamps. Thus, the initiator is preferably a photo-initiator, capable of generating active free radicals and/or anions and/or cations, which are themselves able to initiate polymerization of the said unsaturated reactive monomers and other ingredient of said ink.

The term “color” or “colored” means a color that differs from white. A colored (or color) pigment is a pigment that differs from a white pigment.

The term “tinted” means the outcome of mixing a color with white base

A sub-micron pigment is a pigment that has a size of about one micron or less. It can be at least one hundred nanometers, but this is not necessarily so. For example, it can range between 100 nm to 500 nm.

Colored Ink Formulation

The colored ink (also referred to as the “formulation” or “tinted ink”) is hybrid in the sense that it includes both white sub-micron inorganic pigment (that can be of high density—such as about 4 gr./cm³), with colored sub-micron organic pigment (that can be of a lower density—such as about 1.5 gr./cm³).

The colored ink is stable. It is physically and chemically stable if stored in a certain temperature range (in the case of a thermosetting ink) or/and protected from light (in the case of UV curable ink. For example—the ink can exhibit substantially no precipitation as a result of agglomeration, no change of the physical properties such as viscosity over time. Despite the considerably low volume of the colored sub-micron organic pigment (in the total formulation) it can exhibit good color yield plus good hiding power.

The present invention further provides a method for formulating a colored ink while keeping the hiding power of the colored ink and its important physical properties (like viscosity and surface tension) parameters within a range of the allowed jetting properties of an ink jet).

As a person skilled in the art would recognize, replacing part of a white inorganic pigment with one or more organic pigment results usually in a dramatic viscosity increase. On the other hand, using an organic pigment as the only pigment in the formulation, results in a negligible hiding power of the dry film. Also, simple mixing of white ink with colored organic ink results with non-stable ink formulation.

The illustrated below formulation method provides a colored ink by tinting a white formulation by a colored formulation so as to achieve colored, nano-scale (also referred to as sub-micron) colored ink that has a high hiding power.

The possibility of using wide color range, which exists in the world of organic pigment vs. limited color range which exist in the world of inorganic pigment, provides an ink that can be of different colors. It can allow PCB manufacturers (or other users of this colored ink) with many degrees of freedom for serialization or differentiation of their products.

Thus, in a first aspect, the invention provides a colored ink that includes at least one white inorganic pigment and at least one colored organic pigment, said colored ink being suitable for ink-jet applications. The colored ink is characterized by a stable dispersion, very narrow particle size distribution, and has physical properties (such as viscosity and surface tension) that fit various print head specifications and is chemically compatible with printer parts including print heads and the like.

In one embodiment, the white sub-micron inorganic pigment being in an amount of about 20-35% or between about 20% to about 45 percent of the total weight of the colored ink. It can be Rutile titanium dioxide, Anatase titanium dioxide, barium sulphate or Zinc Oxide.

The formulation requires particle size reduction (for example particle size of about 100-400 nm) of the white inorganic pigment in order to achieve nano-scale particles. The white inorganic pigment grinding process is performed in the presence of monomers and resin blend with dispersing elements.

The white inorganic pigment can be grinded together with resins and monomers that are used as binders or ink film mechanical stabilization (that can make grinding efficient through the dispersing power of these resins to the pigment and grinding energy).

The dispersants interact with the white inorganic pigment and keep them apart through steric or electrical mechanism. The matrix blend (the grinding or milling process) is chosen in a way that substantially no pre-polymerization will occur under the heat evolved as a result of the grinding.

The white inorganic pigment dispersion is diluted with clear solution (also referred to as a first clear solution) in order to provide a first dispersion. The first dispersion can be milled to provide a first milled dispersion. The first milled dispersion can be filtered by a filter to provide the white formulation.

The colored organic pigment can be grinded together with resins and monomers that are used as binders or ink film mechanical stabilization (that can make grinding efficient through the dispersing power of these resins to the pigment and grinding energy).

The dispersants interact with the colored organic pigment and keep them apart through steric or electrical mechanism. The matrix blend (the grinding or milling process) is chosen in a way that substantially no pre-polymerization will occur under the heat evolved as a result of the grinding. Water cooling or other cooling methods can be used to prevent the pre-polymerization.

The colored organic pigment dispersion is diluted with clear solution (also referred to as a second clear solution) in order to provide a second dispersion. The second dispersion can be milled to provide a second milled dispersion. The second milled dispersion can be filtered by a filter to provide the colored formulation.

Accordingly, organic pigment are separately dispersed and ground, with suitable specific dispersing elements, until a nanoscale organic pigment dispersion is obtained. The organic pigment (for example—cromophtal yellow 3G from Ciba) should have a relatively high temperature stability. The dispersing elements can be different from those used for the white inorganic pigment dispersion.

The organic pigment dispersion is diluted with a clear solution in order to obtain a colored formulation. This colored formulation has considerably higher viscosity in comparison to regular ink jet inks, and transparent colored dry film.

Both white and colored formulations are mixed and grind together in various proportion in order to achieve suitable viscosity and good hiding power, color shade, nano-scale particles, and stable colored ink.

The mutual grinding of the colored and white formulations assists in providing a homogeneous colored ink.

A method for preparation of a colored ink is provided. The method includes: preparing a white formulation that comprises sub-micron inorganic pigment; preparing a colored formulation that comprises sub-micron organic pigment; and mixing and grinding the white ink formulation and the colored ink formulation to provide a colored ink formulation suitable for jet ink applications.

The method can include at least one of the following stages or a combination thereof: (1) preparing the white formulation by grinding inorganic pigment to a sub-micron size while preventing substantial pre-polymerization during the grinding; (2) preparing the colored formulation by grinding organic pigment to a sub-micron size while preventing substantial pre-polymerization during the grinding; (3) providing inorganic pigment and organic pigment that have high temperature stability; (4) selecting multiple ingredients of the colored ink to provide a colored ink that is compatible with printed circuit boards applications.

The white formulation can be prepared by: (a) mixing organic ingredients to provide a clear solution; (b) mixing white inorganic pigment with resin and dispersing compounds to provide a first mixture; (c) grinding the first mixture to obtain an inorganic pigment paste; (d) mixing the clear solution with the inorganic pigment paste to obtain a first dispersion; (e) milling the first dispersion to provide a milled dispersion; and (f) filtering the milled dispersion by a sub-micron filter to provide the white formulation.

The white formulation can be prepared by at least one of the following stages or a combination thereof: (i) adding heat sensitive components to the first dispersion; (ii) mixing multiple organic components such as amino resin, phenolic resin, polyols, solvents, monomers, polymers, oligomers, non reactive compounds, defoamers, wetting agents, dispersing agents, and adhesion promoters; (iii) mixing the clear solution with the inorganic pigment paste to obtain a first dispersion; wherein the clear solution is about half of the first dispersion; (iv) mixing the clear solution with the inorganic pigment paste to obtain a first dispersion; wherein the clear solution is between forty to sixty percent of the first dispersion; (v) mixing amino resin that is between 3-15% of the first dispersion with an acidic polymer that is about 2-10% of the first dispersion, an inorganic pigment that is about 20-45% of the first dispersion, an organic solvent that is about 20-55% of the first dispersion, a dispersing agent, a MDEA inhibitor that is about 0.2-0.8% of the first dispersion, and fumed silica that is about 0.5-3% of the first dispersion; (vi) mixing Cymel 325 with SB500E50, Titanium Dioxide, Dowanol PMA, BYK 110, Pluronic F127, MDEA inhibitor and Aerosil 972; (vii) providing the clear solution by mixing amino resin that is between 1-15% of the dispersion with an etherified light color resin that is about 1-20% of the dispersion, an DGEBA polyol that is about 5-35% of the dispersion, an acidic polymer that is about 1-10% of the dispersion; an organic solvent that is about 30-55% of the dispersion, a dispersing agent, fumed silica that is about 0.5-3% of the dispersion and MDEA inhibitor that is about 0.1-0.8% of the dispersion; (viii) mixing Cymel 325 with Schenectady FB210, EPON 1001F, SB500E50, Dowanol PMA, BYK 110, fumed silica and MDEA inhibitor.

The method can include adding heat sensitive components to the first dispersion.

The method can include preparing the white formulation by: (i) mixing organic ingredients to provide a clear solution; (ii) mixing, by a high shear mixer, white inorganic pigment with resin and dispersing compounds to provide a first mixture; (iii) grinding, by a horizontal bead mill loaded by sub-millimeter Yttrium stabilized Zirconium beads, at shaft speed between 1000 to 3000 RPM, for between 30-40 minutes, the first mixture to obtain an inorganic pigment paste; (iv) mixing, by a high shear mixer, the clear solution with the inorganic pigment paste to obtain a first smooth dispersion (thus—the first dispersion can be a smooth dispersion); (iii) milling the first smooth dispersion to provide a first milled dispersion by a horizontal or bead mill loaded by Yttrium stabilized Zirconium beads, at shaft speed between 1000 to 3000 RPM, for between 40-70 minutes until at least 90% of the milled dispersion can pass through a sub micron filter of 1 micron or less; and (iii) filtering the first milled dispersion by the sub-micron filter to provide the white formulation.

The colored formulation can be prepared by: (a) mixing organic ingredients that differ from the color organic pigment to provide clear solution; (b) mixing color organic pigment with resin and dispersing compounds to provide a second mixture; (c) grinding the second mixture to obtain an organic pigment paste; (d) mixing the clear solution with the organic pigment paste to obtain a second dispersion; (e) milling the second dispersion to provide a second milled dispersion; and (f) filtering the second milled dispersion by a sub-micron filter to provide the colored formulation.

The colored formulation can be prepared by at least one of the following stages or a combination thereof: (i) adding heat sensitive components to the second dispersion; (ii) mixing the clear solution with the organic pigment paste to obtain a second dispersion; wherein the clear solution is about half of the second dispersion; (iii) mixing the clear solution with the organic pigment paste to obtain a second dispersion; wherein the clear solution is between fifty to seventy percent of the second dispersion; (iv) mixing amino resin that is between 10-50% of the second dispersion with an organic pigment that is about 5-15% of the second dispersion, an organic solvent that is about 10-25% of the second dispersion, a dispersing agent, a MDEA inhibitor that is about 0.2-2% of the second dispersion, and fumed silica that is about 0.5-3% of the second dispersion; (v) mixing Cymel 325 with Chromophthal y3G, a dispersing agent selected from Disperbyk 168 and Pluronic F127, MDEA inhibitor and Aerosil 972; (vi) providing the clear solution by mixing amino resin that is between 3-15% of the second dispersion with an etherified light color resin that is about 1-15% of the second dispersion, an DGEBA polyol that is about 1-15% of the second dispersion, an acidic polymer that is about 2-10% of the second dispersion; an organic solvent that is about 20-55% of the second dispersion, a dispersing agent, fumed silica that is about 0.5-3% of the second dispersion and MDEA inhibitor that is about 0.2-2% of the second dispersion; (vii) mixing Cymel 325 with Schenectady FB210, EPON 1001F, SB500E50, Dowanol PMA, BYK 110, fumed silica and MDEA inhibitor.

The method can include preparing the colored formulation by: (i) mixing organic ingredients that differ from an organic pigment to provide a clear solution; (ii) mixing, by a high shear mixer, color organic pigment with resin and dispersing compounds to provide a second mixture; (iii) grinding, by a horizontal bead mill loaded by sub-millimeter Yttrium stabilized Zirconium beads, at shaft speed between 1000 to 3000 RPM, for between 30-40 minutes, the second mixture to obtain an organic pigment paste; (iv) mixing, by a high shear mixer, the clear solution with the inorganic pigment paste to obtain a smooth second dispersion (thus—the second dispersion can be a smooth dispersion); (v) milling the smooth second dispersion to provide a milled second dispersion by a horizontal or bead mill loaded by Yttrium stabilized Zirconium beads, at shaft speed between 1000 to 3000 RPM, for between 40-70 minutes until at least 90% of the second milled second dispersion can pass through a sub micron filter of 1 micron or less; and (vi) filtering the milled second dispersion by the sub-micron filter to provide the colored formulation.

Conveniently, the colored ink that is manufactured by any of the mentioned above methods can be used (after being printed and cured) as a legend or as a solder mask. It can be used in PCB applications (printed on PCBs).

Conveniently, the colored ink is a thermosettic ink—it is cured by heat. By including ultraviolet ingredients instead of some heat curable ingredients the colored ink can be ultra violet (UV) cured. By combining both radiation and heat cured ingredients the colored ink can be cured by both heat and UV.

Conveniently, the colored ink that is manufactured by any of the mentioned above methods can be characterized by at least one of the following characteristics: (i) a viscosity of about 11-12 Cps at 45° C., when measured at a shear rate of 3000 sec⁻¹; (ii) a viscosity of about 8-10 Cps at 45° C., when measured at a shear rate of 5000 seq'; (iii) surface tension of 27 to 33 dynes/cm; (iv)

high latency when stored at 20 to 25° C. for 3 months; (v) an increase of less than 2 Cps in its viscosity as measured at 45° C. at a shear rate of 5000 sec⁻¹ after storage of 3 months at 20 to 25° C.; (vi) a very good pigment dispersion.

Conveniently, the colored ink that is manufactured by any of the mentioned above methods can be characterized, once printed and cured provides a print that is characterized by at least one of the following characteristics: (i) a chemical resistance that is compliant with IPC TM-650/2.4.1.1 B and 2.3.4.B, and IPC SM-840C; (ii) an excellent resistance to soldering conditions and has excellent chemical finishes durability.

A colored ink is provided. It can include white sub-micron inorganic pigment and colored sub-micron organic pigment.

The colored ink can be characterized by a high color hiding.

The aggregate volume of the white sub-micron inorganic pigment can be at least twice an aggregate volume of the colored sub-micron organic pigment.

The aggregate volume of the white sub-micron inorganic pigment can be at least thrice an aggregate volume of the colored sub-micron organic pigment.

The aggregate volume of the colored sub-micron organic pigment can be smaller than thirty percent of a volume of the colored ink.

The colored ink can be compatible to printed circuit board application.

Each colored sub-micron organic pigment out of a large group of colored sub-micron organic pigments can be substantially surrounded by multiple white sub-micron inorganic pigments.

The colored ink can include heat sensitive components.

The colored ink can include multiple organic components out of a group consisting of amino resin, phenolic resin, polyols, solvents, monomers, polymers, oligomers, non reactive compounds, defoamers, wetting agents, dispersing agents, and adhesion promoters.

The colored ink can include an amino resin that is between 3-15% of the dispersion, an acidic polymer that is about 2-10% of the dispersion, an inorganic pigment that is about 20-45% of the dispersion, an organic solvent that is about 20-55% of the dispersion, a dispersing agent, a MDEA inhibitor that is about 0.2-0.8% of the dispersion, and fumed silica that is about 0.5-3% of the dispersion.

The colored ink can include Cymel 325, SB500E50, Titanium Dioxide, Dowanol PMA, BYK 110, Pluronic F127, MDEA inhibitor and Aerosil 972.

The colored ink can include amino resin that is between 1-15% of the dispersion, etherified light color resin that is about 1-20% of the dispersion, an DGEBA polyol that is about 5-35% of the dispersion, an acidic polymer that is about 1-10% of the dispersion; an organic solvent that is about 30-55% of the dispersion, a dispersing agent, fumed silica that is about 0.5-3% of the dispersion and MDEA inhibitor that is about 0.1-0.8% of the dispersion.

The colored ink can include Cymel 325, Schenectady FB210, EPON 1001F, SB500E50, Dowanol PMA, BYK 110, fumed silica and MDEA inhibitor.

The colored ink can include Barium Sulfate.

The colored ink can include Zinc Oxide.

The colored ink can include amino resin that is between 10-50% of the dispersion, an organic pigment that is about 5-15% of the dispersion, an organic solvent that is about 10-25% of the dispersion, a dispersing agent, a MDEA inhibitor that is about 0.2-2% of the dispersion, and fumed silica that is about 0.5-3% of the dispersion.

The colored ink can include Cymel 325, Cromophtal yellow 3G, a dispensing agent selected from Disperbyk 168 and Pluronic F127, MDEA inhibitor and Aerosil 972.

The colored ink can include amino resin that is between 3-15% of the dispersion, an etherified light color resin that is about 1-15% of the dispersion, an DGEBA polyol that is about 1-15% of the dispersion, an acidic polymer that is about 2-10% of the dispersion; an organic solvent that is about 20-55% of the dispersion, a dispersing agent, fumed silica that is about 0.5-3% of the dispersion and MDEA inhibitor that is about 0.2-2% of the dispersion.

The colored ink can include Cymel 325, Schenectady FB2010, EPON 1001F, SB500E50, Dowanol PMA, BYK 110, fumed silica and MDEA inhibitor.

The colored ink when printed and cured can provide a solder mask.

The colored ink when printed and cured can provide a legend.

The colored ink can be characterized by at least one of the following characteristics: (i) a viscosity of about 11-12 Cps at 45° C., when measured at a shear rate of 3000 sec⁻¹; (ii) a viscosity of about 8-10 Cps at 45° C., when measured at a shear rate of 5000 sec⁻¹; (iii) a surface tension of 27 to 33 dynes/cm; (iv) a high latency when stored at 20 to 25° C. for 3 months; (iv) an increase of less than 2 Cps in its viscosity as measured at 45° C. at a shear rate of 5000 sec⁻¹ after storage of 3 months at 20 to 25° C.; (v) a very good pigment dispersion.

The colored ink once printed and cured can provides a print that has a chemical resistance that is compliant with IPC TM-650/2.4.1.1B and 2.3.4.B, and IPC SM-840C.

The colored ink once printed and cured can provide a print that has excellent resistance to soldering conditions and has excellent chemical finishes durability.

### Examples of a White Formulation

The white formulation can be prepared according to the following procedure:
A. Mixing multiple organic ingredients e.g., amino resin, phenolic resin, polyols, solvents, monomers, polymers, oligomers, non reactive compounds, defoamers, wetting agents, dispersing agents, and adhesion promoters until a clear solution was obtained.
B. Mixing (also referred to as pre-mixing) and grinding white inorganic pigment with resin and dispersing compounds by high shear mixer followed with horizontal bead mill loaded by 0.4-0.5 mm Yttrium stabilized Zirconium beads, at shaft speed of 1000 to 3000 RPM, for 30-40 minutes until nano scale, stable white inorganic pigment paste was obtained. The white inorganic pigment paste is also referred to as a first mixture.
C. Mixing the clear solution of the mixture by means of high shear mixer with the white inorganic pigment paste until a first smooth dispersion was obtained.
D. Milling first smooth dispersion to provide a first milled dispersion. The milling is done by a horizontal or bead mill loaded by 0.4-0.5 mm Yttrium stabilized Zirconium beads, at shaft speed of 1000 to 3000 RPM, for 40-70 minutes of residence time until at least 90% of the first milled dispersion is able to pass through a 1-or less micron filter.
E. Adding heat sensitive components to the first milled dispersion and mixing by means of a low shear mixer.
F. Filtering the first milled dispersion (also referred to as white liquid ink) by a 1 or less micron filter, thereby obtaining the white formulation (also referred to as white ink formulation).

Formulations

In one example, the first mixture includes: (a) an amino resin such as Cymel 325 by Cytec at a quantity of about 3-15% of the total formulation; (b) an acidic polymer as adhesion promoter/catalyst such as SB500E50 by Sartomer at a quantity of about 2-10% of the first formulation; (c) a pigment such as Kronos 2310 Titanium Dioxide at a quantity of about 20-45% of the first formulation; (d) an organic solvent such as Dowanol PMA manufactured by DOW and/or Propylene Carbonate and for and or Dipropylene glycole methyl ether or/and combination thereof, at quantities ranging from 20 to 55% of the first formulation; (e) a dispersing agent such as BYK 110 and Pluronic F127 to stabilize said pigment particles from sedimentation and hard cake formation; (f) MDEA inhibitor at an amount of about 0.2-0.8% of the ink weight in order to extend pot life and shelf life; and (g) Fumed silica as Aerosil 972 at quantity of about 0.5-3% of the first formulation for improving rheological behavior.

In one example, the clear solution used for formulating the white formulation includes: (a) an amino resin such as Cymel 325 by Cytec at a quantity of about 1-15% of the total formulation; (b) etherified light color phenolic resin such as Schenectady FB210 B60 by Schenectady at a quantity of about 1-20% of the total formulation; (c) DGEBA polyol such as EPON 1001F by Resolution at a quantity of about 5-35% of the total formulation; (d) an acidic polymer as adhesion promoter/catalyst such as SB500E50 by Sartomer at a quantity of about 1-10% of the total formulation; (e) an organic solvent such as Dowanol PMA manufactured by DOW and/or Propylene Carbonate and/or and or Dipropylene glycole methyl ether or/and 2-butanol and/or combination thereof, at quantities ranging from 30 to 55% of the total formulation; (e) a dispersing agent such as BYK 110; (f) MDEA inhibitor at an amount of about 0.1-0.8% of the ink weight in order to extend pot life and shelf life; and (g) Fumed silica as Aerosil 972 at quantity of about 0.5-3% of the total formulation for improving rheological behavior.

The white formulation includes about 40-60% of the first mixture and 40-60% of the clear solution.

Colored Formulation—Few Examples

The colored formulation can be prepared according to the following procedure:
A. Mixing multiple organic ingredients e.g., amino resin, phenolic resin, polyols, solvents, monomers, polymers, oligomers, non reactive compounds, defoamers, wetting agents, dispersing agents, and adhesion promoters until a clear solution is obtained.
B. Mixing (also referred to as pre-mixing) and grinding colored Organic pigment with resin and dispersing compounds by high shear mixer followed with horizontal bead mill loaded by 0.4-0.5 mm Yttrium stabilized Zirconium beads, at shaft speed of 1000 to 3000 RPM, for 30-40 minutes until nano scale, to obtain a second mixture that is also referred to as a colored stable pigment paste.
C. Mixing the clear solution by means of high shear mixer with the second mixture until a smooth dispersion was obtained (thus—the second dispersion is a smooth dispersion).
D. Milling the second dispersion to provide a second milled dispersion. The milling is done by a horizontal or bead mill loaded by 0.4-0.5 mm Yttrium stabilized Zirconium beads, at shaft speed of 1000 to 3000 RPM, for 40-70 minutes until at least 90% of the second milled dispersion is able to pass through a 1-or less micron filter.
E. Adding heat sensitive components to the second milled dispersion and mixing by means of a low shear mixer.

The colored organic pigment paste formulation can include: (i) an amino resin such as Cymel 325 by Cytec at a quantity of about 10-50% of the second formulation; (ii) an organic pigment such as Cromophthal y3G at a quantity of about 5-15% of the second formulation; (iii) an organic solvent such as Dowanol PMA manufactured by DOW and/or Propylene Carbonate and for combination thereof, at quantities ranging from 10 to 25% of the second formulation; (iv) a dispersing agent such as Disperbyk 168 and Pluronic F127 to stabilize said pigment particles from sedimentation and hard cake formation; (iv) MDEA inhibitor at an amount of about 0.2-2% of the ink weight in order to extend pot life and shelf life; and (v) Fumed silica as Aerosil 972 at quantity of about 0.5-3% of the second formulation for improving rheological behavior.

The clear solution for colored formulation can include: (i) an amino resin such as Cymel 325 by Cytec at a quantity of about 3-15% of the second formulation; (ii) etherified light color phenolic resin such as Schenectady FB210 B60 by Schenectady at a quantity of about 1-15% of the second formulation; (iii) DGEBA polyol such as EPON 1001F by Resolution at a quantity of about 1-15% of the second formulation; (iv) an acidic polymer as adhesion promoter/catalyst such as SB500E50 by Sartomer at a quantity of about 2-10% of the second formulation; (v) an organic solvent such as Dowanol PMA manufactured by DOW and/or Propylene Carbonate and/or and or Dipropylene glycole methyl ether or/and 2-butanol and/or combination thereof, at quantities ranging from 20 to 55% of the second formulation; (vi) a dispersing agent such as Disperbyk 168 and Pluronic; (vii) MDEA inhibitor at an amount of about 0.2-2% of the ink weight in order to extend pot life and shelf life; and (viii) Fumed silica as Aerosil 972 at quantity of about 0.5-3% of the second formulation for improving rheological behavior.

The colored formulation can include 50-70% of colored paste formulation and 30-50% of the clear formulation.

Mixing and Grinding the White and Colored Formulations

The white formulation and colored formulations can be: (i) mixed by high shear mixer, (ii) grinded with horizontal bead mill loaded by 0.4-0.5 mm Yttrium stabilized Zirconium beads, at shaft speed of 1000 to 3000 RPM, for 50-70 minutes until stable nano scale, and (iii) filtered through a 1-or less micron filter.

The colored ink can include 60-70% of white formulation and 30-40% of the colored formulation.

Physical Characteristics:

The resulting colored ink exhibited excellent properties which make it suitable for use as a marking ink in the PCB industry.

The colored ink was measured to have a viscosity of about 12-16 Cps at 45° C., when measured at a shear rate of 6000 sec⁻¹; surface tension of 27 to 34 dynes/cm; excellent latency when stored at 20 to 25° C. for 3 months; and showed an increase of less than 2 Cps in its viscosity as measured at 45° C. at a shear rate of 6000 sec⁻¹ after storage of 3 months at 20 to 25° C.

Additionally, the pigment dispersion was very good. No hard cake was formed during storage. After storage at ambient for 3 months, only a slight agitation was required in order to re-disperse the pigment. The properties of the stored colored ink were the same as those of the original colored ink, with the exception of the slight increase in viscosity discussed above.

An Example of an Application and Curing of the Ink:

The inks were printed by digital ink jet (Printar model LGP 809 and 509) onto PCB board (substrate FR4, solder mask Taiyo PSR4000—fully cured, Solder mask Printar SMI 100, fully and semi cured). The inks were air dried for 5 minutes, cured 90 minutes at 150 Celsius. The color was examined by a BYK Gardner Spectro guide 45/0 and chemical resistance according to several internal tests. Latency was measured as an increase of the viscosity as a result of exposure of ink to storage at 45° C. for a week, to simulate 2 months storage at ambient. Grinding efficiency was evaluated by Grindometer by BYK Gardner.

The colored ink was applied by ink Jet printer (LGP 809 manufactured by Printar LTD, Israel) onto a solder mask (type Taiyo PSR-4000) coated printed circuit board and cured. The ink cured at temperatures in the range of 150 to 180° C. showed film and character resistance.

The chemical resistance of the print was very good and passed all criteria listed in IPC TM-650/2.4.1.1B and 2.3.4.B, and IPC SM-840C that relates to solder mask applications (The IPC standards are international specifications established by the Institute of Interconnecting and Packaging Electronic Circuits). Additionally, the formulation exhibited excellent resistance to soldering conditions (Pb—Sn solder+organic flux, 230-288° C., 5-30 seconds exposure, 5 repeating exposures followed by tape adhesion test) or chemical finishes such as immersion tin, Electroless Ni/Au, OSP (Organic soldering preservative), immersion silver and electroplating (Ni and Au). Prints cured 30 minutes at 180° C. had similar chemical and physical properties as prints cured 60 minutes at 160° C. and prints cured 90 minutes at 150° C.

Ink Jet Printing Using the Mentioned Above Colored Ink

A method is provided for ink jet printing, the method includes: providing colored ink such as either one of the colored ink mentioned above; ink-jetting the colored ink onto a substrate; and curing the ink-jetted colored ink. The substrate can be a PCB.

A method is provided for ink jet printing, the method includes: manufacturing (fabricating) a colored ink in any of the mentioned above methods; ink-jetting the colored ink onto a substrate; and curing the ink-jetted colored ink. The substrate can be a PCB.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

1. A method for preparation of a colored ink comprising: preparing a white formulation that comprises sub-micron inorganic pigment; preparing a colored formulation that comprises sub-micron organic pigment; and mixing and grinding the white ink formulation and the colored ink formulation to provide a colored ink formulation suitable for jet ink applications.

2. The method according to claim 1 comprising preparing the white formulation by grinding inorganic pigment to a sub-micron size while preventing substantial pre-polymerization during the grinding; and comprising preparing the colored formulation by grinding organic pigment to a sub-micron size while preventing substantial pre-polymerization during the grinding.

3. The method according to claim 1 comprising providing inorganic pigment and organic pigment that have high temperature stability.

4. The method according to claim 1 comprising selecting multiple ingredients of the colored ink to provide a colored ink that is compatible with printed circuit boards applications.

5. The method according to claim 1 comprising preparing the white formulation by: mixing organic ingredients to provide a clear solution; mixing white inorganic pigment with resin and dispersing compounds to provide a mixture; grinding the mixture to obtain an inorganic pigment paste; mixing the clear solution with the inorganic pigment paste to obtain a dispersion; milling the dispersion to provide a milled dispersion; filtering the milled dispersion by a sub-micron filter to provide the white formulation.

6. The method according to claim 5 comprising adding heat sensitive components to the dispersion.

7. The method according to claim 5 comprising mixing multiple organic components out of a group consisting of amino resin, phenolic resin, polyols, solvents, monomers, polymers, oligomers, non reactive compounds, defoamers, wetting agents, dispersing agents, and adhesion promoters.

8. The method according to claim 5 comprising mixing the clear solution with the inorganic pigment paste to obtain a dispersion; wherein the clear solution is about half of the dispersion.

9. The method according to claim 5 comprising mixing the clear solution with the inorganic pigment paste to obtain a dispersion; wherein the clear solution is between forty to sixty percent of the dispersion.

10. The method according to claim 5 comprising mixing amino resin that is between 3-15% of the dispersion with an acidic polymer that is about 2-10% of the dispersion, an inorganic pigment that is about 20-45% of the dispersion, an organic solvent that is about 20-55% of the dispersion, a dispersing agent, a MDEA inhibitor that is about 0.2-0.8% of the dispersion, and fumed silica that is about 0.5-3% of the dispersion.

11. The method according to claim 5 comprising mixing Cymel 325 with SB500E50, Titanium Dioxide, Dowanol PMA, BYK 110, Pluronic F127, MDEA inhibitor and Aerosil 972.

12. The method according to claim 5 comprising providing the clear solution by mixing amino resin that is between 1-15% of the dispersion with an etherified light color resin that is about 1-20% of the dispersion, an DGEBA polyol that is about 5-35% of the dispersion, an acidic polymer that is about 1-10% of the dispersion; an organic solvent that is about 30-55% of the dispersion, a dispersing agent, fumed silica that is about 0.5-3% of the dispersion and MDEA inhibitor that is about 0.1-0.8% of the dispersion.

13. The method according to claim 5 comprising mixing Cymel 325 with Schenectady FB210, EPON 1001F, SB500E50, Dowanol PMA, BYK 110, fumed silica and MDEA inhibitor.

14. The method according to claim 5 comprising adding heat sensitive components to the dispersion.

15. The method according to claim 1 wherein the inorganic pigment is Barium Solfate.

16. The method according to claim 1 wherein the inorganic pigment is Zinc Oxide.

17-43. (canceled)

44. A colored ink comprising: white sub-micron inorganic pigment and colored sub-micron organic pigment; wherein an aggregate volume of the white sub-micron inorganic pigment is at least twice an aggregate volume of the colored sub-micron organic pigment.

45. (canceled)

46. A colored ink comprising white sub-micron inorganic pigment and colored sub-micron organic pigment; wherein an aggregate volume of the colored sub-micron organic pigment is smaller than thirty percent of a volume of the colored ink.

47-48. (canceled)

49. The colored ink according to claim 44 comprising heat sensitive components.

50. The colored ink according to claim 44 comprising multiple organic components out of a group consisting of amino resin, phenolic resin, polyols, solvents, monomers, polymers, oligomers, non reactive compounds, defoamers, wetting agents, dispersing agents, and adhesion promoters.

51-75. (canceled)
